(19) United States
(12) Patent Application Publication
(10) Pub. No.: US 2012/0228269 A1
(43) Pub. Date: Sep. 13, 2012

(54) ELECTRICAL DISCHARGE MACHINING WITH THICK WIRE ELECTRODE

(76) Inventors: Dimitrios Thomaidis, Berlin (DE); Rene Weisheit, Ludwigsfelde (DE)

(21) Appl. No.: 13/508,612

(22) PCT Filed: Nov. 10, 2010
(86) PCT No.: PCT/EP10/67180

§ 371 Date: May 8, 2012

(30) Foreign Application Priority Data
Nov. 12, 2009 (EP) 09014187.0

(51) Int. Cl. B23H 1/00

(52) U.S. Cl. 219/69.11

(57) ABSTRACT

A process of electrical discharge machining using a wire electrode is provided. The use of a thick wire electrode means that the surface can be machined considerably more accurately. The wire electrode has a diameter of at least 2.0 mm. In a first step for machining the surface, a rough contour is produced on the component.

### CROSS REFERENCE TO RELATED APPLICATIONS

This application is the US National Stage of International Application No. PCT/EP2010/067180, filed Nov. 10, 2010 and claims the benefit thereof. The International Application claims the benefits of European Patent Office application No. 09014187.0 EP filed Nov. 12, 2009. All of the applications are incorporated by reference herein in their entirety.

### FIELD OF INVENTION

The invention relates to an electrical discharge machining process with a cutting wire electrode.

### BACKGROUND OF INVENTION

Cast components are often remachined further after casting, such as e.g. the fir-tree profiles of blade or vane roots.

To date, this has been done by means of grinding.

### SUMMARY OF INVENTION

It is an object of the invention, therefore, to specify an improved manufacturing process.

The object is achieved by a process as claimed in the claims.

The dependent claims list further advantageous measures which can be combined with one another, as desired, in order to obtain further advantages.

### BRIEF DESCRIPTION OF THE DRAWINGS

FIGS. 1, 2 schematically show the arrangement of a component and of a wire electrode,

FIG. 3 shows a turbine blade or vane, and

FIG. 4 shows a list of superalloys.

The figures and the description represent only exemplary embodiments of the invention.

### DETAILED DESCRIPTION OF INVENTION

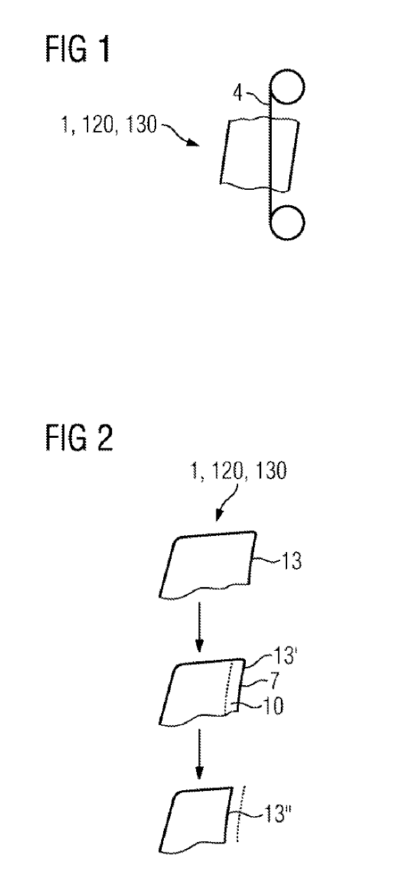

FIG. 1 schematically shows a part of a component 1, in particular of a turbine blade or vane 120, 130, which is machined by means of a cutting wire electrode 4 and has a surface 13.

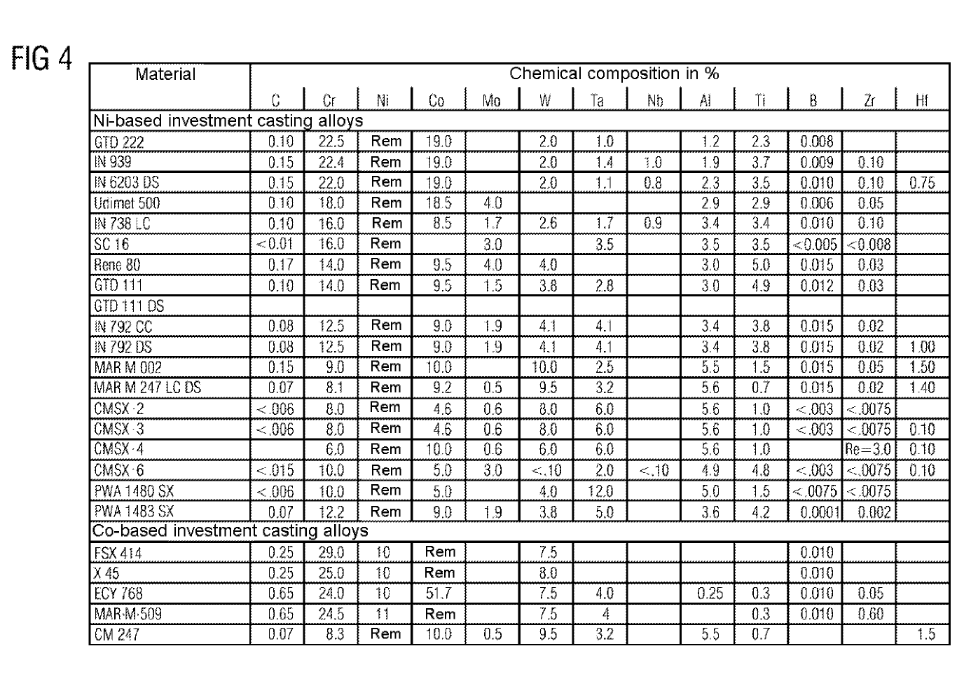

The turbine blades or vanes 120, 130 preferably comprise a superalloy as per FIG. 4.

The wire electrode 4 has a diameter of at least 1.0 mm and preferably up to 4 mm, preferably various minimum values or no values depending on the radius to be machined.

This achieves a machining speed and accuracy which has not been achieved to date.

The surface 13″ of the component 1, 120, 130 is produced in at least two steps (FIG. 2).

In the main cut, a rough contour 13′ is produced by the wire electrode 4 proceeding from the surface 13. A heat-affected zone 10 (the region between the surface 13′ and the dotted line) is formed underneath the rough contour 13′.

In at least one subsequent cut, in particular in a plurality of successive subsequent cuts, with a preferably gradually reduced discharge energy, the heat-affected zone 10 from the preceding machining is machined off.

By virtue of the reduction, a heat-affected zone 10 which is produced by machining in the component will become ever smaller or ultimately vanishes.

The final contour 13″ is shown in FIG. 2, with the former course of the surface 13′ being shown as a dashed line. The gap demonstrates that the zone 10 has been removed.

In this context, in addition to achieving a specific surface roughness and dimensional accuracy, the intention is to reduce the thickness of the heat-affected marginal zone 10.

By using a CNC program, the component 120, 130 moves in relation to the wire electrode 4 (FIG. 1), such that any desired contours can be produced by the superposition of the movement in the X and Y directions. The complex manufacturing of the grinding disks is therefore no longer required.

Wire erosion is a force-free process and does not require any costly force-absorbing clamping systems, and can therefore be used to manufacture various types of rotor blades flexibly.

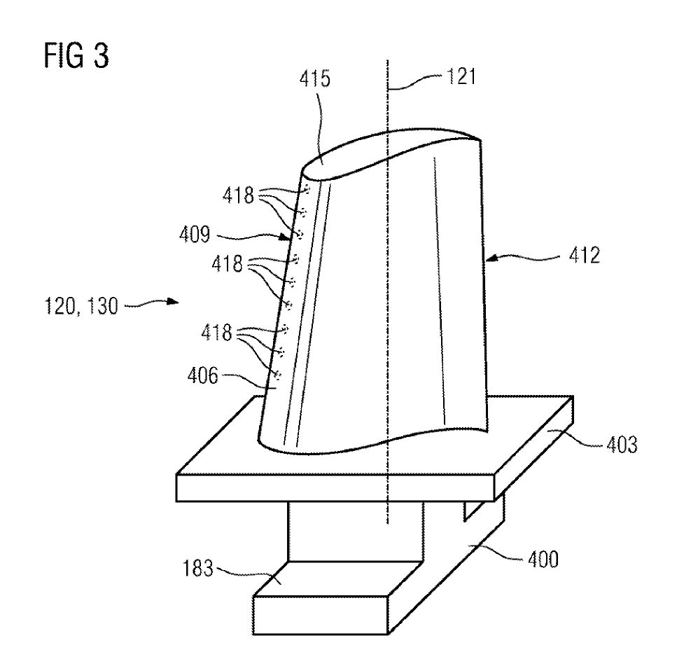

FIG. 3 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO= thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer, to be present on the MCrAlX, consisting for example of ZrCh, Y₂O₃—ZrO₂, i.e. unstabilized, partially stabilized or fully stabilized by yttrium oxide and/or calcium oxide and/or magnesium oxide.

The thermal barrier coating covers the entire MCrAlX layer. Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1-4. (canceled)

5. A process of electrical discharge machining, comprising:
machining a surface of a component by means of a cutting wire electrode,
wherein the wire electrode has a diameter of at least 2.0 mm.

6. The process as claimed in claim 5,
wherein in a main cut as a first step for machining the surface, a rough contour is produced on the component, and
wherein in a first subsequent cut, the marginal layer of the rough contour is remachined.

7. The process as claimed in claim 6,
wherein, in a second subsequent cut or the successive subsequent cuts, the discharge energy is reduced with respect to the discharge energy of the main cut.

8. The process as claimed in claim 7, wherein the discharge energy is reduced gradually.

9. The process as claimed in claim 5,
wherein the diameter of the wire electrode is at most 4 mm.

10. The process as claimed in claim 9,
wherein the diameter of the wire electrode is at most 3 mm.

11. The process as claimed in claim 5,
wherein the diameter of the wire electrode is 2 mm.
